(19) United States
(12) Patent Application Publication
(10) Pub. No.: US 2023/0091059 A1
(43) Pub. Date: Mar. 23, 2023

(54) INFLATABLE GROW TENT WITH INTEGRATED LIGHTING

(71) Applicant: Poseidon Reef Systems LLC, Malvern, PA (US)

(72) Inventor: Elliott Gruskin, Malvern, PA (US)

(21) Appl. No.: 17/992,812

(22) Filed: Nov. 22, 2022

Related U.S. Application Data
(63) Continuation-in-part of application No. 17/072,881, filed on Oct. 16, 2020.
(60) Provisional application No. 62/915,957, filed on Oct. 16, 2019.

(51) Int. Cl. A01G 9/16; A01G 9/24

(52) U.S. Cl. CPC A01G 9/16; A01G 9/249

(57) ABSTRACT

Self-supporting inflatable grow tents include a base surface, a top surface, and a plurality of sidewalls. The sidewalls include an integrated lighting system. The inflatable grow tents include a plurality of support members configured to structurally support the grow tent when inflated, and an air circulation assembly including an air blower and a carbon filter. The grow tents include a lighting system configured to provide a standard deviation of average photosynthetic active radiation that is from about 2 to about 8 within the grow tent when the lighting system is active.

### CROSS-REFENENCE TO RELATED APPLICATIONS

This application is a continuation-in-part of U.S. patent application Ser. No. 17/072,881, filed on Oct. 16, 2020 and entitled “Inflatable Grow Tent with Integrated Lighting,” which claims the benefit of U.S. Provisional Application No. 62/915,957 filed Oct. 16, 2019, the entire disclosures of which are incorporated by reference for all purposes.

### BACKGROUND

Traditional agricultural methods are labor intensive, land intensive, and dependent on local climate and weather conditions. Various indoor farming technologies have been developed to address these problems to produce yields in controlled environments.

Often times, grow tents provide a suitable enclosure for growing plants indoors. However, due to complex frameworks, lighting systems, air handling equipment, and associated cables and tubes, grow tents are multi-component systems that can take considerable time to set up. It would be desirable to manufacture inflatable grow tents that require minimal effort from a user to setup.

Conventional grow tents have a conventional grow light (“CGL”) suspended from an internal framework inside the grow tent. A very bright light is used so that sufficient light reaches plants at various positions within the grow tent. Due to the inverse square law of light intensity, an overhead light provides a steep gradient of diminishing light intensity with the distance from the light. The brightest intensity is at the upper level of the grow tent, closest to the light, and much less intensity at the lower levels, farther away from the light. Plants that grow several feet tall will have intense lighting at the top of the plants and much less light below. Shadowing caused by branches and foliage exacerbate the problem.

It would also be desirable to provide for a lighting system configured to provide an optimal distribution of light within a grow tent.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

In one aspect, an inflatable grow tent comprises a base surface, a top surface, and a plurality of sidewalls, the sidewalls being of a light material and including an integrated lighting system having a two-dimensional array of light emitting diodes (“LEDs”) attached to at least one of the plurality of sidewalls. A plurality of support members are configured to structurally support the grow tent. The grow tent has an air circulation assembly including an air blower and a carbon filter, the air blower blowing air to inflate the grow tent. An additional source of light is adjacent the top surface of the grow tent.

The plurality of support members can be poles. In embodiments, the sidewalls have an exterior made from canvas. In embodiments, the sidewalls have an interior that is reflective. For example, the interior of the sidewalls can comprise Mylar.

The plurality of support members can form a frame external of the plurality of sidewalls. In embodiments, the LEDs are disposed in parallel rows extending towards the top surface

In embodiments, the LEDs are attached to the at least one of the plurality of sidewalls by fabric reinforced clips. For example, the fabric reinforced clips can be attached to the at least one of the plurality of sidewalls by sewing.

In embodiments, the LEDs are attached by clips extending in horizontal rows. In embodiments, the LEDs re a plurality of LED strips.

In a further aspect, an inflatable grow tent comprises a base surface, a top surface, and a plurality of sidewalls, the sidewalls including an integrated lighting system having a two dimensional array of light emitting diodes (“LEDs”) attached to at least one of the plurality of sidewalls. A plurality of support members is configured to structurally support the grow tent. The grow tent has an additional light source adjacent the top surface.

The plurality of support members can be poles.

In embodiments, the sidewalls have an exterior made from canvas. The sidewalls can have an interior that is reflective. For example, the interior of the sidewalls comprises Mylar. In embodiments, the LEDs are disposed in parallel rows extending towards the top surface.

In embodiments, the plurality of support members form a frame external of the plurality of sidewalls. The plurality of support members can be connected by a plurality of connectors.

The grow tent can further include an accessory attachment member positioned adjacent an exterior of one of the plurality of sidewalls, the accessory attachment member including a metal plate and a support configured to receive the support member therethrough.

In embodiments, the grow tent further includes an accessory positioned adjacent an interior of the one of the plurality of sidewalls in alignment with the accessory attachment member, the accessory including a magnetic portion configured to attach to the metal plate of the accessory attachment member. For example, the accessory includes a hook.

The grow tent further includes an air circulation assembly including an air blower and a carbon filter.

In embodiments, the LEDs are attached to the at least one of the plurality of sidewalls by fabric reinforced clips. For example, the fabric reinforced clips are attached to the at least one of the plurality of sidewalls by sewing.

In embodiments, the LEDs are attached by clips extending in horizontal rows. In embodiments, the LEDs re a plurality of LED strips.

In a further aspect, a method of installing an inflatable grow tent comprises providing an external support system having an upper support, a lower support, and a plurality of side supports extending between the upper support and the lower support. The grow tent is placed inside the support system, the grow tent having a base surface, a top surface, and a plurality of sidewalls, the base surface, top surface and plurality of sidewalls being made of a light material. The grow tent has a source of light attached to at least one of the sidewalls. Air is introduced into the grow tent to inflate the grow tent.

In embodiments, the grow tent is attached to the support system.

In embodiments, the light source is a plurality of LEDs attached to at least one of the sidewalls in a two-dimensional array. The LEDs can be connected to a power source.

In embodiments, the source of light is attached to the at least one sidewall by sewing. In embodiments, an additional light source is attached to the top surface.

### BRIEF DESCRIPTION OF THE DRAWINGS

FIG. 1 is a front view of a grow tent in accordance with an illustrative embodiment of the present disclosure;

FIG. 1A is a front view of a grow tent in accordance with another illustrative embodiment of the present disclosure;

FIG. 2 depicts a diagrammatic view of a sidewall of a grow tent in accordance with an illustrative embodiment of the present disclosure;

FIG. 3 depicts a diagrammatic cross-sectional view of a sidewall of a grow tent in accordance with an illustrative embodiment of the present disclosure;

FIG. 3A depicts a sidewall of a grow tent in accordance with an illustrative embodiment of the present disclosure;

FIG. 4 depicts a rear view of a grow tent in accordance with an illustrative embodiment of the present disclosure;

FIG. 4A depicts a rear view of a grow tent in accordance with another illustrative embodiment of the present disclosure;

FIG. 5 depicts a top down view of the base of a grow tent in accordance with an illustrative embodiment of the present disclosure;

FIGS. 6-10 are tables depicting photosynthetic active radiation data for a grow tent in accordance with an illustrative embodiment of the present disclosure having an integrated LED lighting system compared to an incandescent lighting system at varying distances from the base of the grow tent;

FIG. 11 is a graph depicting average light intensity data for a grow tent in accordance with an illustrative embodiment of the present disclosure having LED lighting compared to known incandescent lighting at varying distances from the base of the grow tent;

FIG. 12 is a graph depicting the standard deviation of light intensity data for a grow tent in accordance with an illustrative embodiment of the present disclosure having LED lighting compared to known incandescent lighting at varying distances from the base of the grow tent;

FIG. 13 depicts a diagrammatic cross-sectional view of a sidewall of a grow tent in accordance with a second illustrative embodiment of the present disclosure;

FIG. 14 depicts a diagrammatic cross-sectional view of a sidewall of a grow tent in accordance with a third illustrative embodiment of the present disclosure;

FIG. 15 depicts a sidewall of a grow tent in accordance with an illustrative embodiment of the present disclosure;

FIG. 16 depicts a sidewall and a top surface of a grow tent in accordance with an illustrative embodiment of the present disclosure.

FIG. 17 depicts a metal frame of a grow tent in accordance with an illustrative embodiment of the present disclosure;

FIGS. 18A and 18B depict an accessory attachment member of a grow tent in accordance with an illustrative embodiment of the present disclosure;

FIG. 19 depicts the sidewall of a grow tent in accordance with an illustrative embodiment of the present disclosure including an accessory attachment member having an accessory attached thereto;

FIG. 20 depicts a grow tent in accordance with an illustrative embodiment of the present disclosure including a metal frame;

FIG. 21 is a front perspective view of a grow tent according to a further embodiment;

FIG. 22 is a plan of the material for the grow tent, according to embodiments;

FIG. 23 is an elevation view of a sidewall of the grow tent having a plurality of LED strips;

FIG. 24 is a detailed view of attachment hooks according to embodiments;

FIG. 25 is a schematic showing the coordinates for measurements taken;

FIG. 26 is a graph showing the average vertical PAR values for a grow tent having an array of LED strips (“HLA”), a grow tent having a conventional grow light (“CGL”), and a grow tent having both an HLA and a CGL;

FIG. 27 is a graph showing average horizontal PAR values, by distance from the bottom of the grow tent, for the HLA, CGL, and HLA-CGL grow tents;

FIG. 28 is a graph showing the average of all PAR values for the HLA, CGL, and HLA-CGL grow tents by distance from bottom of the grow tent;

FIG. 29 is a graph showing the standard deviation in PAR, by the distance from the bottom of the grow tent, for the HLA, CGL, and HLA-CGL grow tents;

FIG. 30 is a graph showing cumulative and horizontal PAR values, by the distance from the botton of the grow tent, for the HLA, CGL, and HLA-CGL grow tents; and

FIG. 31 is a graph showing cumulative vertical and horizontal PAR, by the distance from the botton of the grow tent, for the HLA, CGL, and HLA-CGL grow tents.

### DETAILED DESCRIPTION

Particular embodiments of the inflatable grow tents are described herein below. However, it is to be understood that the disclosed embodiments are merely exemplary of the disclosure and may be embodied in various forms. Therefore, specific details disclosed herein are not to be interpreted as limiting, but merely as a basis for the claims and as a representative basis for teaching one skilled in the art to variously employ the present disclosure in virtually any appropriately detailed structure. Well-known functions are not described in detail to avoid obscuring the present disclosure in unnecessary detail.

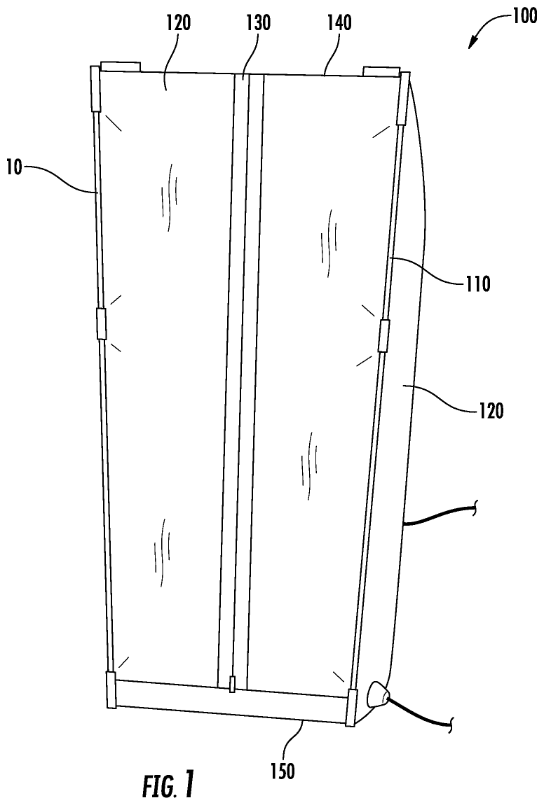

As seen in FIG. 1, the present grow tent 100 includes support members 110, sidewalls 120, zipper 130, top surface 140, and base surface 150. In embodiments, sidewalls 120, top surface 140, and base surface 150 may be made from any suitable material that is light enough to be easily inflated and supported by support members 110 (also referred to herein as “support poles 110”. In embodiments, support members 110 may be support poles. In embodiments, sidewalls 120, top surface 140, and base surface 150 may be Mylar-backed canvas, having the reflective Mylar material facing the inside of grow tent 100. In embodiments, grow tent 100 is a rectangular prism, however, other desired shapes may be used with designs in accordance with the present disclosure. Sidewalls 120 and top surface 140 are supported by support poles 110. Support poles 110 may include an inner shock cord surrounded by a flexible layer. In embodiments, the support poles are iron pipes. Support poles may be made from plastics, or any suitable material with the requisite strength to support grow tent 100 and its contents when inflated. Support poles 110 may be present on the exterior edges of sidewalls 120, top surface 140, and base surface 150. Support poles 110 may be secured to sidewalls 120, top surface 140, and base surface 150 by any suitable means. For example, in one embodiment, the support poles 110 may be inserted into fabric pockets or loops (not shown) formed on each corner of sidewalls 120, top surface 140, and base surface 150. In embodiments, support poles 110 may only be included along the vertical edges 122 of sidewalls 120 and along two edges of top surface 140. In another embodiment, two support poles may form an “X” shapes along top surface 140. In other words, the number and configuration of support poles 110 may be modified so long as the structural integrity and self-supporting nature of grow tent 100 remains intact. In addition to providing structural integrity, support poles 110 ensure grow tent 100 does not collapse in the event of power failure.

Grow tent 100 further includes a zipper 130 extending vertically along a substantially central portion of a desired sidewall 120. Zipper 130 provides a mechanism by which a user may enter grow tent 100, while also ensuring grow tent 100 is sealed in a substantially airtight fashion. In embodiments zipper 130 extends along a sidewall 120 on the front side of grow tent 100, such that the entryway to grow tent 100 provided by zipper 130 is isolated from other components of grow tent 100. In alternative embodiments, as shown in FIG. 1A, zipper 130 may be substantially C-shaped, allowing for easier access into grow tent 100.

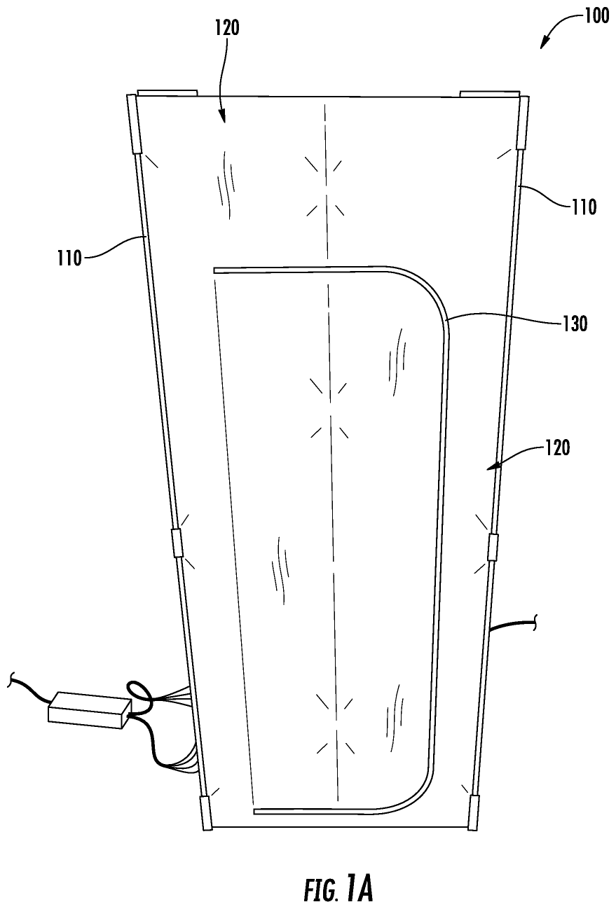

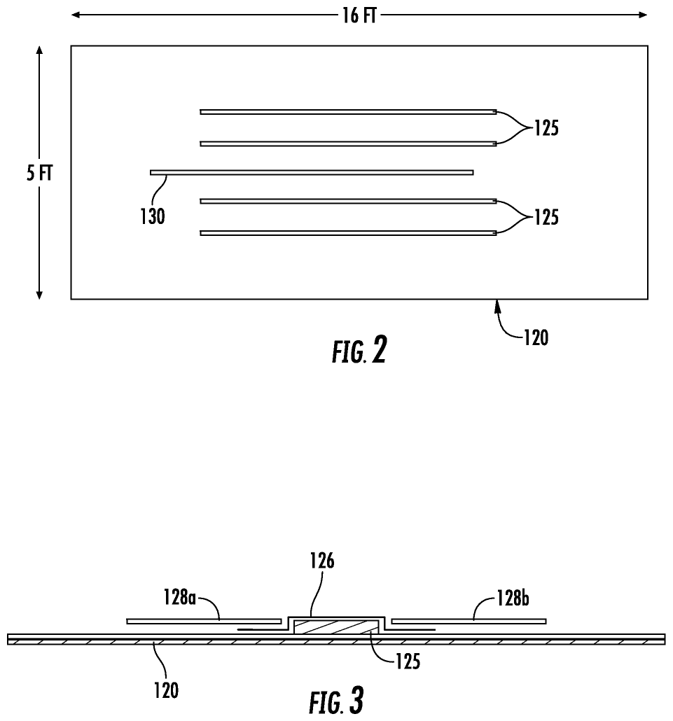

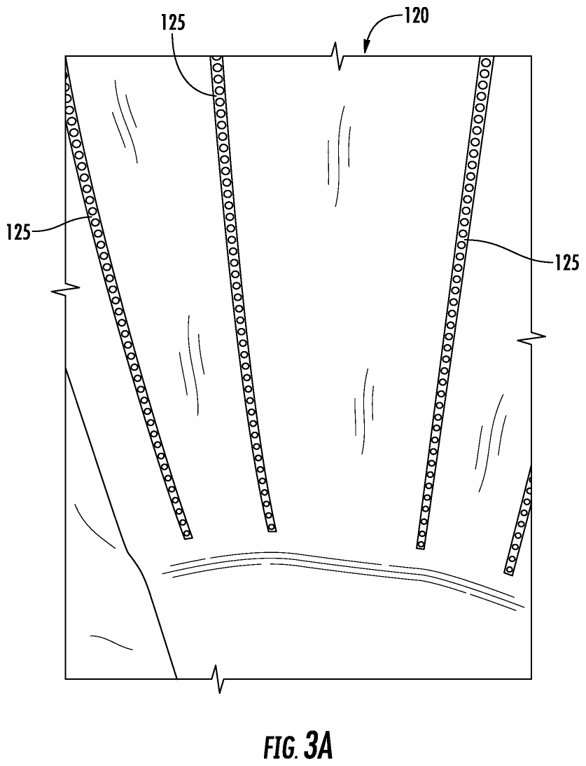

FIGS. 2 and 3 show diagrammatic views of a sidewall 120 of a grow tent 100 in accordance with an illustrative embodiment of the present disclosure. In FIG. 2, the sidewall 120 is on the front of grow tent 100 and includes zipper 130. A series of light strips 125 extend along sidewall 120 and may be substantially parallel to zipper 130. Light strips 125 may be LED lights, and may be secured to sidewalls 120 using a suitable adhesive, or any other suitable securing means. LED's are desirable as they are lightweight and are decreasing in cost over time. In embodiments, there may be two light strips on either side of zipper 130 on the front side of grow tent 100. As shown in the cross-sectional view depicted in FIG. 3, light strips 125 may be secured directly to the Mylar (inside) side of sidewalls 120. In embodiments, a water-resistant or water-proof seal 126 may cover light strips 125. In embodiments, seal 126 may be clear tape. A first end of reflective metal tape 128a is then secured to Mylar sidewall 120, while a second end of reflective metal tape 128b is secured to seal 126. Thus, reflective metal tape 128a, 128b further secures seal 126 to light strips 125 and provide additional reflective surfaces for the light within grow tent 100.

In embodiments, light strips 125 are integrated within grow tent 100. Light strips 125 may be secured to grow tent 100 via sewing, adhesive, or any suitable securing means.

Because of the relatively low weight of the LED lights that form light strips 125, those of ordinary skill in the art reading this disclosure will appreciate that once inflated, grow tent 100 is self-sustaining and prepared for use, obviating the need for structural frames required to suspend heavier lighting systems and for any form of installation of lighting systems after inflation of grow tent 100. Because light is most intense near the light source and then light intensity decreases with distance following the inverse square law, light within a conventional grow tent has a steep intensity gradient from the top of the grow tent, immediately under the suspended light and the base of grow tent where the plants are located. Plants that grow several feet tall will have intense lighting at the top of the plants and much less light below. Shadowing caused by branches and foliage exacerbate this problem. In contrast, the grow tent described here has LED light strips integrated into the reflective inner surface. The LED light strips of the present disclosure are provided in parallel rows that start along sidewalls 120 near base surface 150 of grow tent 100 and extend towards top surface 140 creating a more even distribution of light, as best seen in FIG. 3A. The uniformity of light distribution is further enhanced within grow tent 100 by the relatively extended surface length of light strips 125 allowing the light to be reflected throughout grow tent 100 by the Mylar inner surface of sidewalls 120. Consequently, in use, plants within grow tents in accordance with the present disclosure are evenly exposed to light at a minimal intensity gradient. In addition, the upper foliage will not be subjected to the greatest light intensity, thereby minimizing overexposure. The distribution of light within grow tent 100 will be further described below.

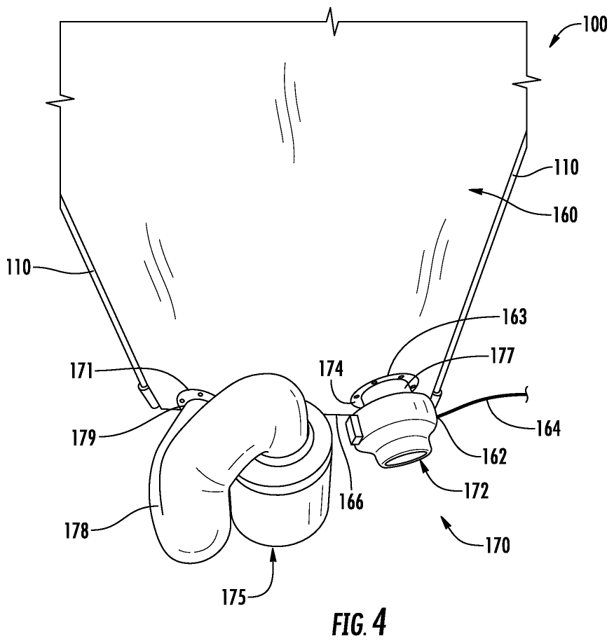

FIG. 4 illustrates a rear view of rear wall 160 of grow tent 100. Rear wall 160 includes an electrical outlet 162 for receiving a wire 164 connected to a suitable power source 165 (see FIG. 5). Wire 164 provides electricity to power electrical components of grow tent 100. In embodiments, electrical outlet 162 may be installed into a cutout 163 formed near an edge 166 of rear wall 160 adjacent base surface 150. Wires 164 may also run along the perimeter of base surface 150 (as best seen in FIG. 5). In embodiments, rear wall 160 may further include an air circulation assembly 170. Air circulation assembly 170 includes an air blower 172, carbon filter 175, and air ducts 177,178. Air blower 172 is secured to air duct 177 which is fitted into a hole formed on rear wall 160 of grow tent 100. Air duct 177 may be secured within a hole formed on grow tent 100 via a gasket 174 in combination with adhesives, screws, or any other suitable securing means. Air blower 172 provides the air needed to inflate grow tent 100, while also providing for adequate circulation of fresh air and oxygen needed to keep grow tent 100 inflated and functioning throughout use. Carbon filter 175 is to be secured to grow tent 100 by the same means used to secure air blower 172, namely securing carbon filter 175 to an air duct 178 that is secured to a cutout 171 in grow tent 100 via a gasket 179. Carbon filter 175 serves as a ventilation system for moving air out from the interior of grow tent 100 and functions to eradicate odors from grow tent 100. Carbon filter 175 may be a charcoal carbon filter, a centrifugal fan, or any similar device that may function as a ventilation system for grow tent 100. In embodiments, as shown in FIG. 4A, air exhaust duct 178 may be secured to an upper portion of grow tent 100 and may extend in a downward direction towards carbon filter 175 positioned at the base of grow tent 100. Because air blower 172 remains near the base of grow tent 100, this configuration allows for directional airflow driven by the positions of air blower 172 and air exhaust duct 178. Additionally, power source 165 and its connective components may be positioned outside grow tent 100 if additional space is desired within grow tent 100.

FIG. 5 shows a top-down view of the base surface 150 of grow tent 100. Base surface 150 may include a mat 155. In embodiments, mat 155 is rubber to provide a surface that is easy to grip for the contents of grow tent 100 to prevent unwanted movement. As shown in FIG. 5, power source 165 may rest on base surface 150 of grow tent 100. Power source 165 may be a battery, a generator, or any suitable power source for powering the electrical components of grow tent 100. One or more transformers are used, in embodiments.

In addition to removing the need for installation of lighting systems and associated structural frameworks, grow tents in accordance with the present disclosure provide for a more uniform distribution of light intensity within grow tent 100.

Testing of photosynthetic active radiation (PAR) was conducted on a grow tent in accordance with the present disclosure. A 2 foot by 2 foot rubber pad was placed on the base surface inside the grow tent. A grid was drawn on the pad dividing it into 24, 6-inch squares. The integrated LED lights were switched on and allowed to reach a stable operating temperature and intensity for 4 hours before any measurements were taken. An Apogee light meter, model MQ-210, was used for all light measurements and readouts were recorded in units of photosynthetic active radiation (PAR). The light sensor of the PAR meter was fixed onto a 6-inch square tile using double sided tape. The tile was then placed into each square of the grid drawn on the rubber mat and PAR values were recorded at the base of the grow tent and at 12, 24, 36, and 48-inch distance from the base.

A second set of PAR measurements were taken using the same grow tent as used in the first data set to compare the integrated LED lighting system to an incandescent lighting system. The integrated LED lights were switched off and a 120-watt, incandescent grow light in a reflector fixture was secured to the top of the grow tent. The incandescent light was switched on and PAR measurements were recorded for the same data points as outlined in the first data set described above.

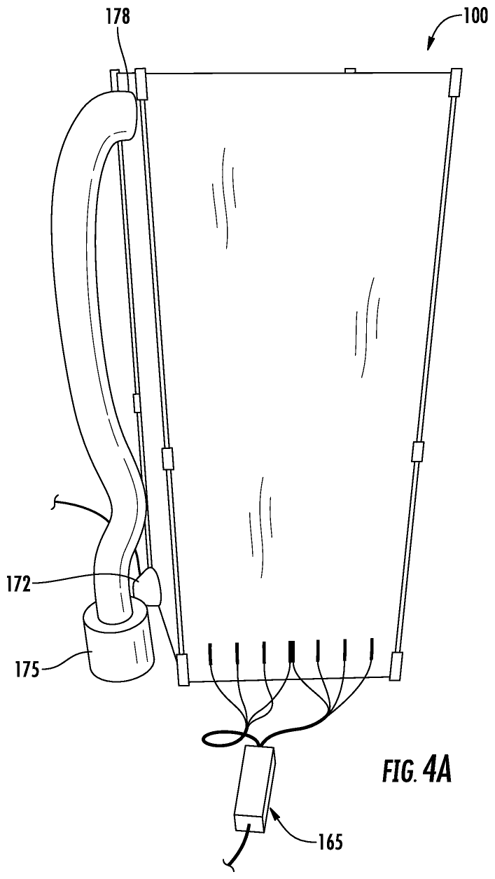

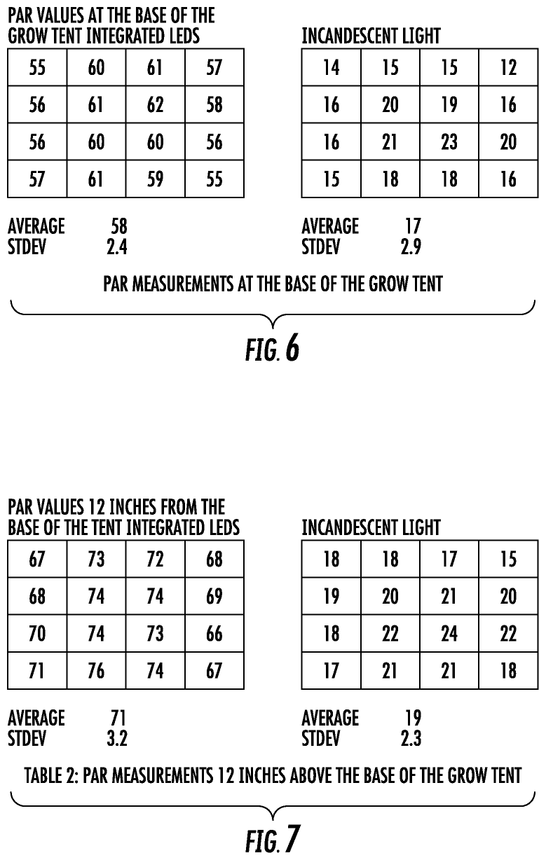

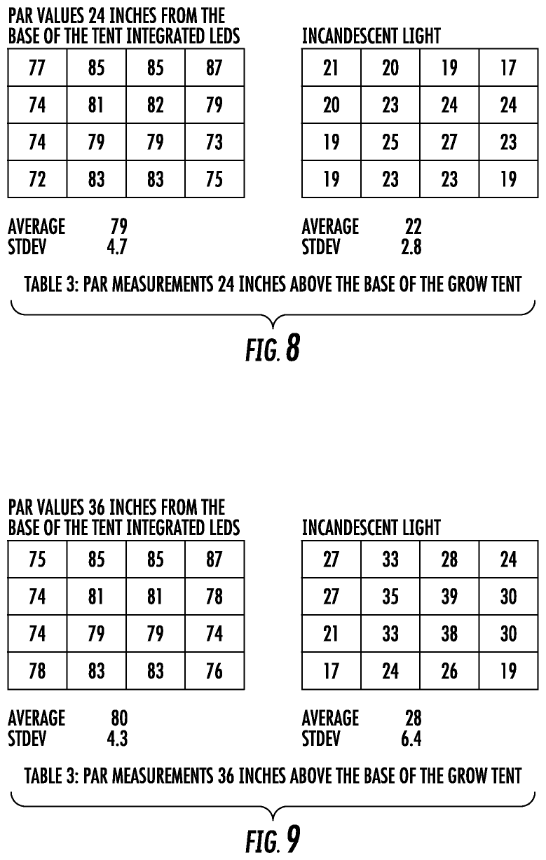

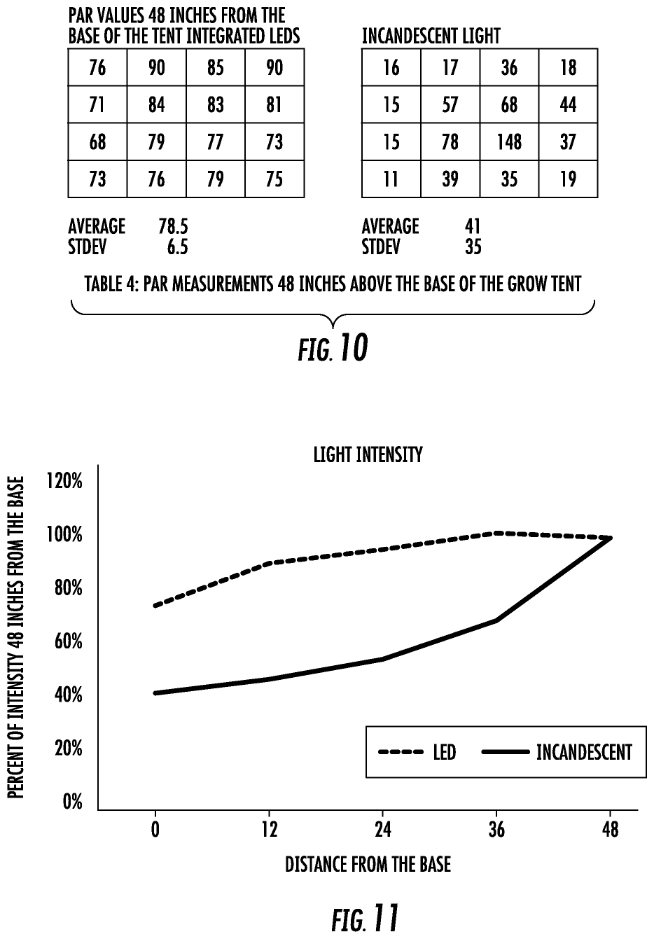

The tables shown in FIG. 6-10 depict the photosynthetic active radiation data recorded for a grow tent in accordance with an illustrative embodiment having an integrated LED lighting system, and an incandescent light fixture. Inspection of the tabulated data reveals that the PAR values for the integrated LED system is more consistent and evenly distributed compared to the incandescent light situated at the apex of the interior of the grow tent.

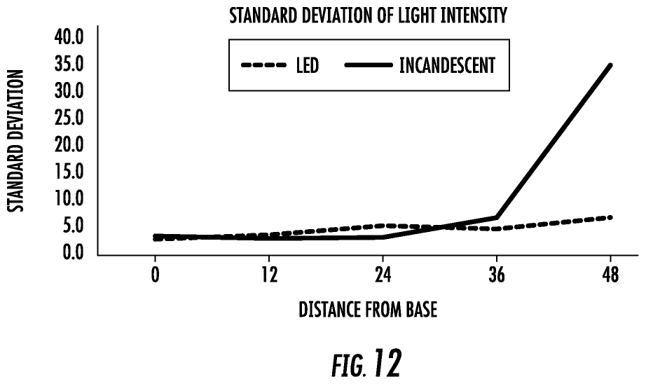

These data sets are further illustrated graphically in FIGS. 11 and 12. In FIG. 11, the average PAR values were calculated from each data set at the base of the grow tent and at 12, 24, 36 and 48 inches above the base of the grow tent. The percentage values are comparisons of the average light intensity at each distance from the base compared to the average PAR value for the 48-inch measurements. The plot reveals that the LED system provides a more even distribution of light. Inspection of the data also reveals that the variability of the PAR values is more significant for the incandescent light particularly for the values obtained close to the light source.

In FIG. 12, the standard deviation of the average PAR value was calculated from each data set at the base of the grow tent and at 12, 24, 36 and 48 inches above the base of the grow tent. The lighting system using the LED light strips of the present disclosure provided a standard deviation of average photosynthetic active radiation that ranged from about 2 to about 8, while the standard deviation for the incandescent light is significantly greater as the distance to the light is decreased.

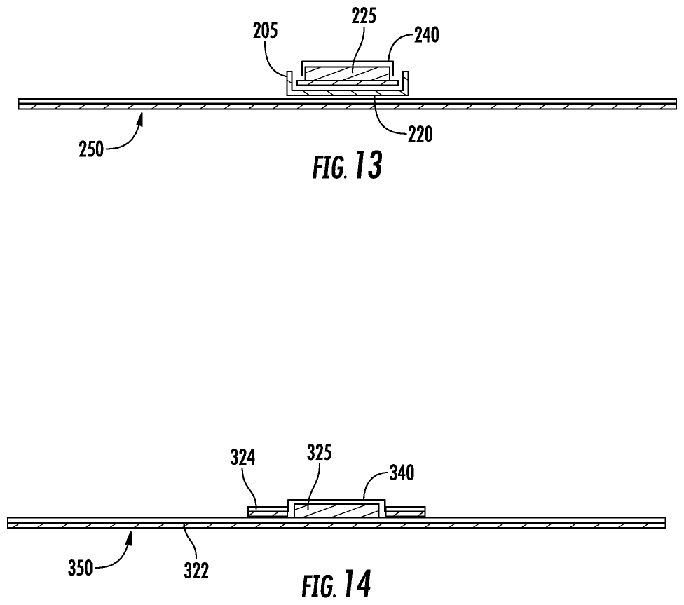

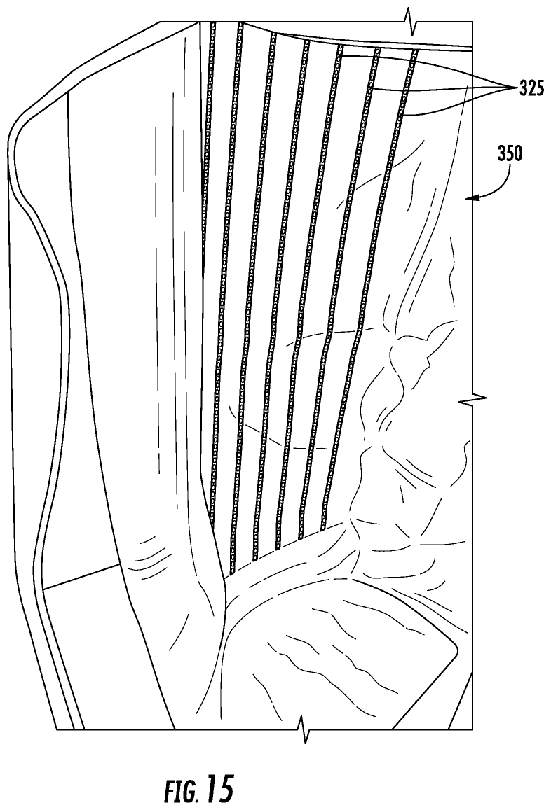

In an alternative embodiment, as shown in FIG. 13, a sidewall 250 of an illustrative grow tent may include a series of light strips 225 adhered to a base strip 220. Base strip 220 may be configured to engage with a track 205 formed on the grow tent to secure light strips 225 to the grow tent. Track 205 may be formed by sewing or any other suitable process. A coating 240 may be secured to light strips 225. Coating 240 may be waterproof and made from plastic tape, or other suitable plastics or materials. In yet another embodiment, shown in FIG. 14, an illustrative grow tent may include light strips 325 configured to run along the sidewalls 350 of grow tent within a channel 320 formed on grow tent 300. Channel 310 may be formed by sewing or any other suitable process for forming channel 310. In this embodiment, the sidewalls 350 of the grow tent may include mylar-coated canvas having a multiple canvas layers 322 and mylar layers 324 in various alternating or repeating arrangements as desired. As shown in FIGS. 15 and 16, light strips 325 may extend along varying lengths of sidewalls 350 and top surface 360 as desired.

In embodiments 24 volt LED strip lights may be used, such as, for example, SMD2835 24 Watts per meter 6500k color LED strip lights. A grow tent employing SMD2835 24 Watts per meter 6500k color LED lights was found to have an average interior brightness of about 350 PAR compared to 12 volt LED lights that averaged about 70 PAR. In any of the embodiments disclosed herein, 12 volt or 24 volt LED light strips may be used.

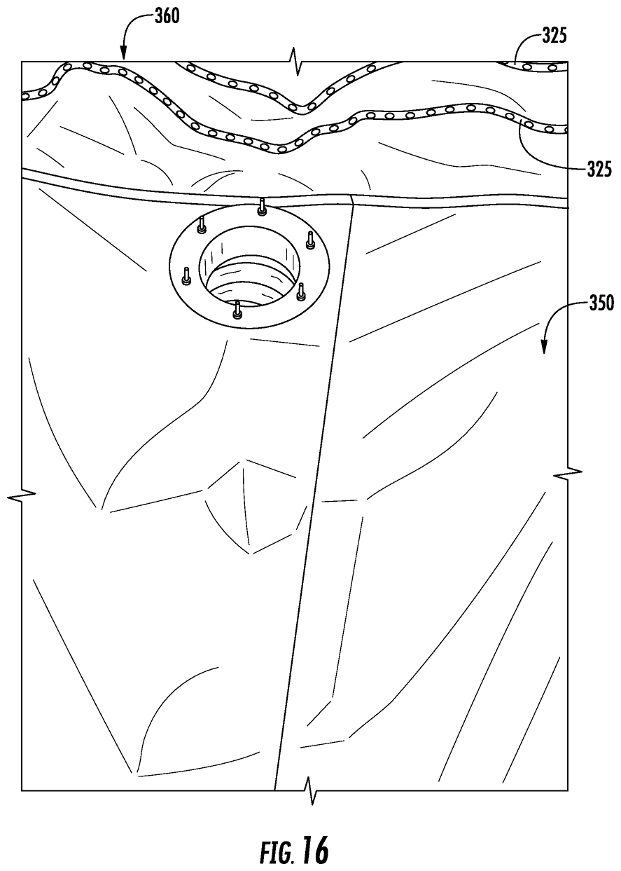

In further embodiments, an inflatable grow tent 400 (FIGS. 17-20), may include an external frame 405 made of support rods 410. Support rods 410 may be made from any suitable material, and be of any desired dimensions suitable for providing an exterior frame 405 to support grow tent 400. In embodiments, support rods 410 may be, for example, ¾-inch metal (e.g. aluminum) conduits or polypropylene tubing. As shown in FIG. 17, support rods 410 may be connected to adjacent support rods via connectors. In embodiments, frame 405 may include one or more two-way connectors 412 and one or more three-way connectors 414 as desired. Other types of suitable connectors may be used to connect any number of support rods to provide a desired configuration for frame 405. As in previous embodiments, inflatable tent 400 may include sidewalls 420, a top surface 440 and a base surface (not expressly shown) that may be secured to exterior frame 405 by any suitable means. For example, in embodiments, grommets or fabric loops (not shown) at or near the top of sidewalls 420 may be placed over the tops of support rods 410. Other methods for supporting sidewalls 420 on support rods 410 will be apparent to one skilled in the art reading this disclosure.

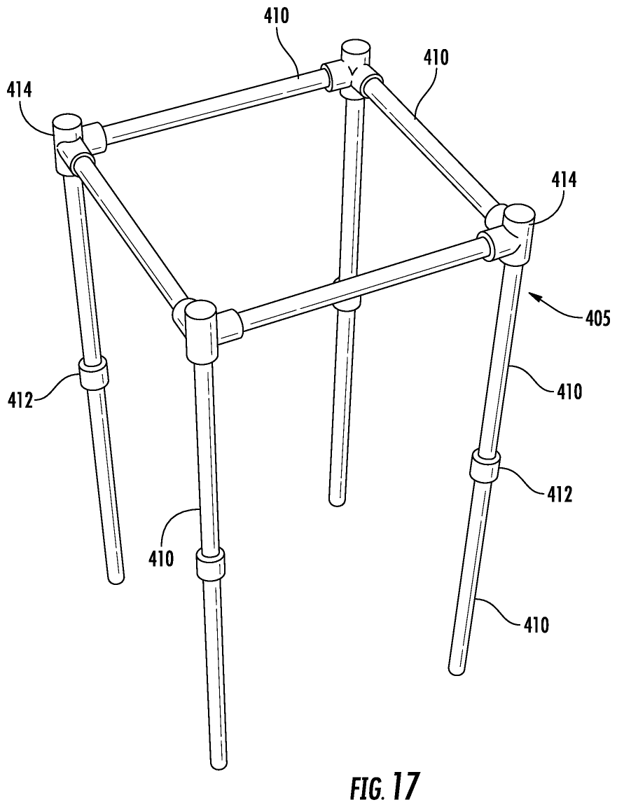

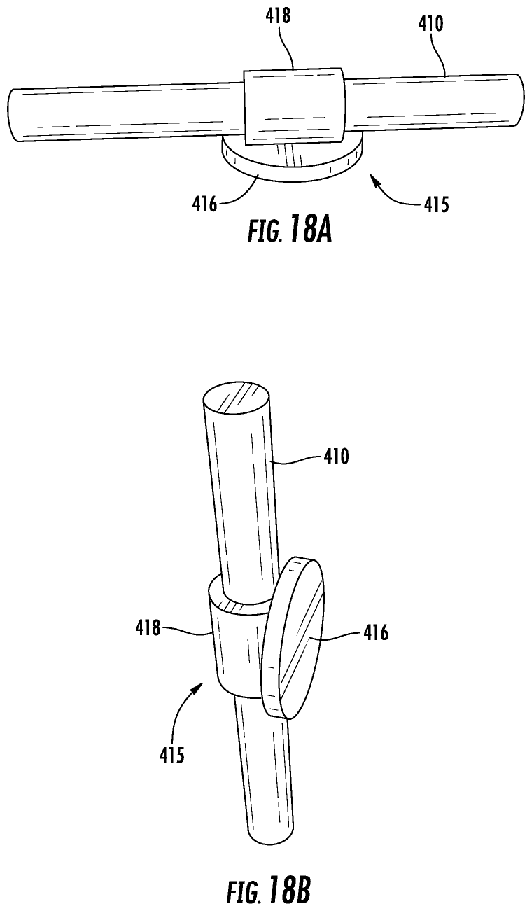

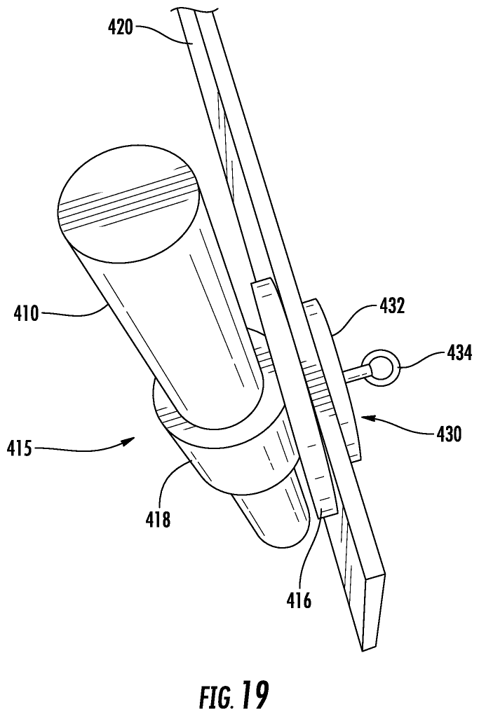

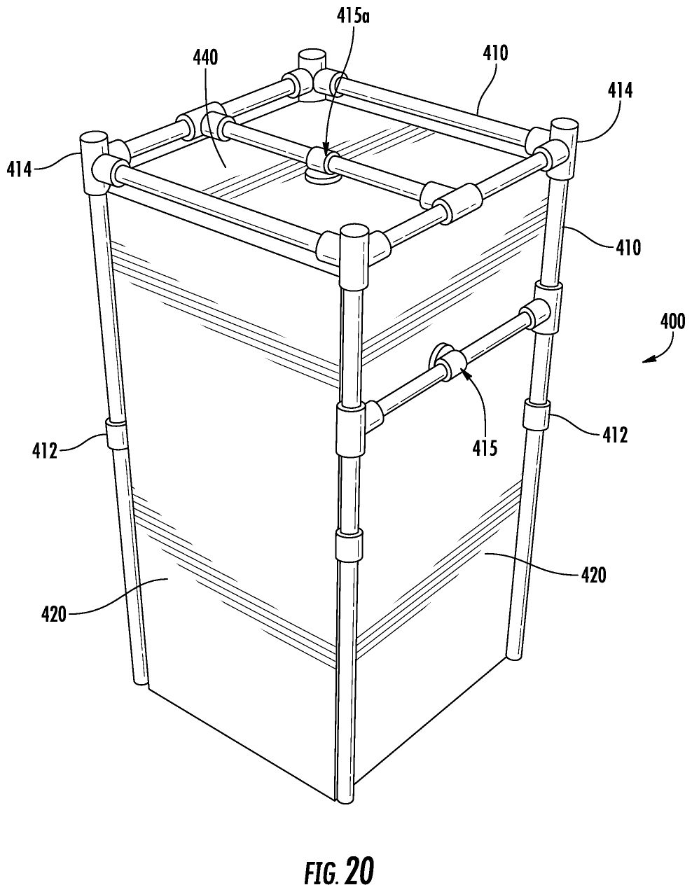

In embodiments, grow tent 400 may further include an accessory attachment member 415, including a metal plate 416 positioned on a support 418 (FIGS. 18A and 18B). Support 418 is configured to receive a support rod 410 therethrough. In embodiments, metal plate 416 may be positioned on a connector, provided the connector is positioned at a location at which it is desired to suspend an accessory. As best seen in FIGS. 19 and 20, metal plates 416 may be in contact with, or in close proximity to the exterior of a sidewall 420 of grow tent 400. An accessory 430 having a magnetic portion 432 is positioned in contact with, or in close proximity to the interior of sidewall 420 in alignment with metal plate 416. In this manner, an accessory 430, held in place by the magnetic attraction between magnetic portion 432 of accessory 430 and metal plate 416, may be suspended within the interior of grow tent 400.

In embodiments, the accessory 430 may include a hook or eyelet 434, or any other desired accessories for use within the interior of grow tent 400. A second accessory may be suspended from top surface 440 on the interior of grow tent 400 in a similar manner by magnetic attraction to accessory attachment member 415a. In embodiments, the accessory attachment member may include a magnet and the accessory may include a metal plate. In other embodiments, each of the accessory attachment member and the accessory may include a magnet, the magnets being of opposite polarity to ensure adequate attraction. Once positioned on the interior of grow tent 400, accessory 430 may be used to suspend any type of structure desired within tent 400 (e.g. using wires, strings, or chords (not shown)), and may be capable of supporting 50 pounds or more.

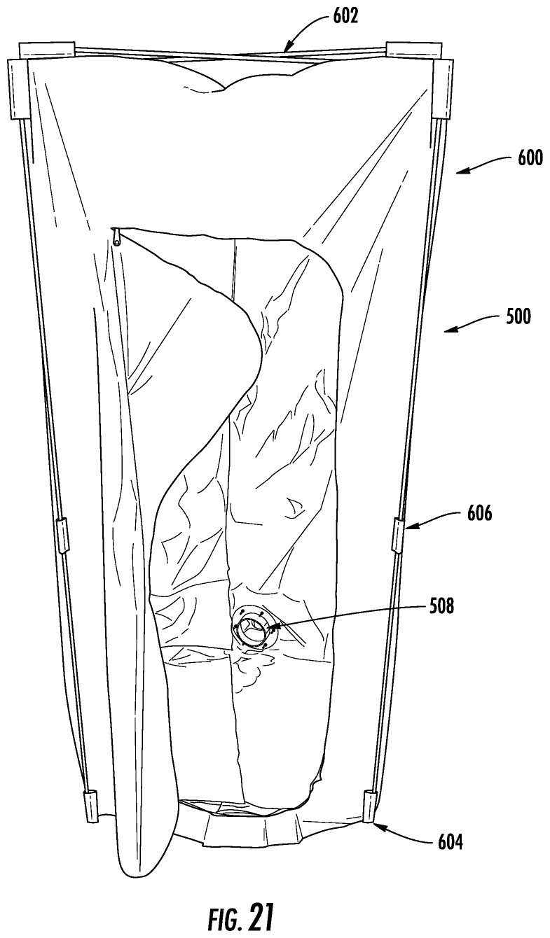

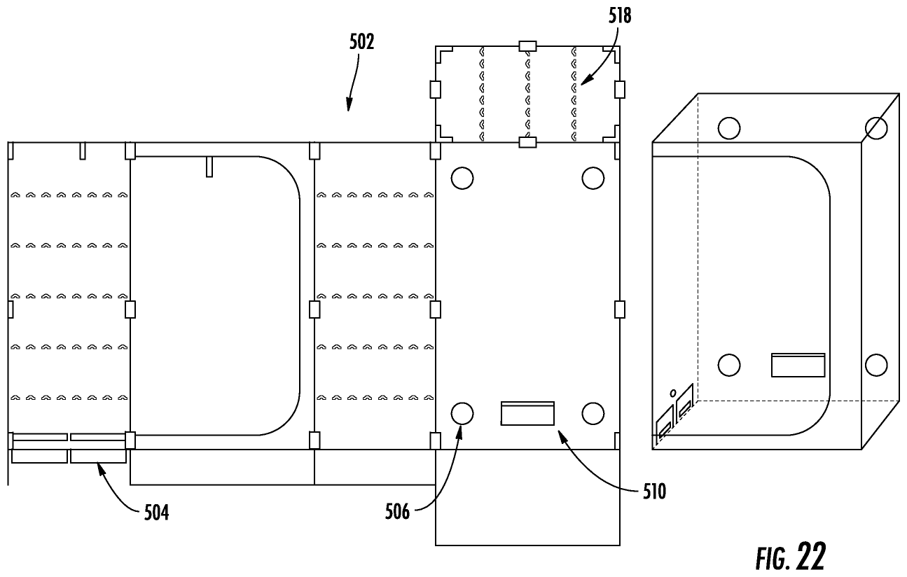

A further embodiment of a grow tent 500 is shown in FIGS. 21-23. In embodiments, a 120 centimeter by 60 centimeter by 180 centimeter grow tent 500 is fabricated from mylar-backed canvas. For example, the fabric can be 600D Lychee fabric. In embodiments, the tent is made using conventional manufacturing methods such as sewing. A pattern 502 for sewing the grow tent in embodiments is shown in FIG. 22. Air ducts 508 are attached to the grow tent to provide an air inlet for inflation and cooling of the grow tent and an air outlet for the air to escape. For example, there are four gusseted holes 506 for air ducts and one rectangular screened vent 510 as shown in FIG. 22. A mesh window, in embodiments, is included near the bottom of the rear sidewall. In embodiments, there is a pocket or a pair of pockets 504 on the outside of the tent to hold the LED power supplies, as shown in FIG. 22. In embodiments, one or more transformers are used. For example, the pockets are about 28 centimeters wide, there are two pocket, and two transformers are used. The pole system described above can be used to support the grow tent when the air blower is interrupted or the zipper is opened and air escapes. The poles, in embodiments, are attached to the material of the grow tent using fabric ties, Velcro straps, loops or the like. The poles provide an external support system 600 and include an upper support 602, a lower support 604, and a plurality of side supports 606 extending between the upper support and lower support.

In embodiments, the integrated LED array (“HLA”) 512 consists of a plurality of LED strips 514 attached to the canvas and Mylar material, with the strips extending in parallel rows from a position near the bottom of the grow tent to a position near the top of the grow tent. The grow tent has a plurality of LED strips 514 on at least one sidewall, or the LEDs are otherwise provided in a two-dimensional array 512 on at least one sidewall. In embodiments, a two-dimensional array of LEDs is provided on two sidewalls of the grow tent. In embodiments, a two-dimensional array of LEDs is provided on two sidewalls of the grow tent and an additional light source 516 is provided at the top of the grow tent. The additional light source at the top of the grow tent can be one or more LEDs, a conventional grow light, an incandescent light, LED light or lights, or other source of light.

In embodiments, the LEDs are secured to the sidewallsand/or top surface by clips. The clips, in embodiments, extend in horizontal rows. For example, rows of clips are spaced about 33 centimeters on the sidewalls and about 30 centimeters on the top surface. In the example shown in FIG. 22, the holes 506 are spaced about 10 centimeters from the edges of the sidewalls and about 16 centimeters from the top or bottom edges of the sidewalls.

For example, the LED strips extend on at least one sidewall of the grow tent. The LED strips, in another example, extend on a sidewall, on the top of the grow tent, and down the opposite sidewall.

In an example, eight, 5-meter-long LED strips (White 2835 LED Light Strip—4000K, 240 LEDs per meter, 20 Watts per meter, 24 volt DC) are secured to the canvas and Mylar material. IIn embodiments, 12 volt or 24 volt LEDs can be used. In embodiments, the LED strips 514 are secured using fabric-reinforced silicone clips 518 attached to the material, as shown in FIG. 24. In embodiments, the fabric reinforcement is sewn to the material of the grow tent. In an example, the LEDs are energized by two, 320 watt power supplies (uPowerTek, Model BLD-400-V024-NNU) in a parallel configuration.

In embodiments, the grow tent 500 is provided with the LED strips sewn into the material of the grow tent, or otherwise attached. The pole support system 600 is assembled and the grow tent is placed inside the support system. The air blower 520 is attached to the air duct 508 and the tent is inflated. The LED strips 514 are pre-installed, so there is no need to install lighting. The inflated grow tent can be attached to the support poles by fabric loops, ties, Velcro straps or the like. In embodiments, the air duct 508 is provided near the base of the grow tent and the exhaust is near the top. In embodiments, an additional grow light 516 is installed at the top of the grow tent. In embodiments, a plurality of LED strips 514 extend on a first sidewall of the grow tent, across the top of the grow tent, and down a second sidewall of the grow tent, the second sidewall being opposite the first sidewall.

In an example, a grow tent having a conventional grow light was compared to a grow tent having an LED array. A 120 centimeter by 60 centimeter by 180 centimeter grow tent is fabricated from mylar-backed canvas. Eight, 5-meter-long LED strips (White 2835 LED Light Strip - 4000K, 240 LEDs per meter, 20 Watts per meter, 24V DC) are secured to the canvas and Mylar material. In the example, the LEDs are energized by two, 320 watt power supplies (uPowerTek,Model BLD-400-V024-NNU) in a parallel configuration.

Photosynthetic active radiation (“PAR”) measurements were taken to compare the LED strips to a conventional grow light (“CGL”). The CGL used for this PAR study was the GROWBRIGHT Neofold One 480-watt LED light. The CGL was suspended as close to the top of the tent as possible using magnetic hooks that were secured to the pole system on the outside of the tent. The LED strip extended to 8 inches from the top of the tent. Measurements were taken with the HLA alone, with the CGL mounted in the tent, and with both the HLA and CGL.

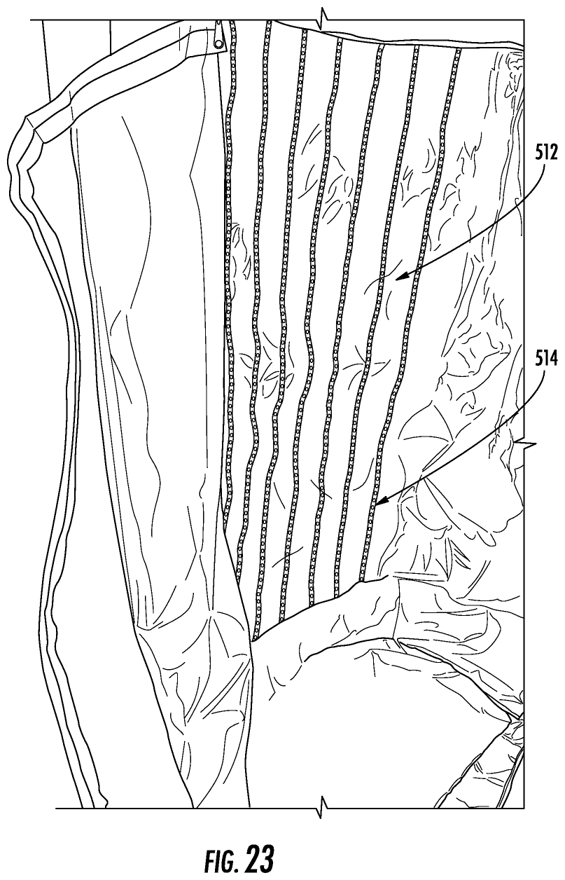

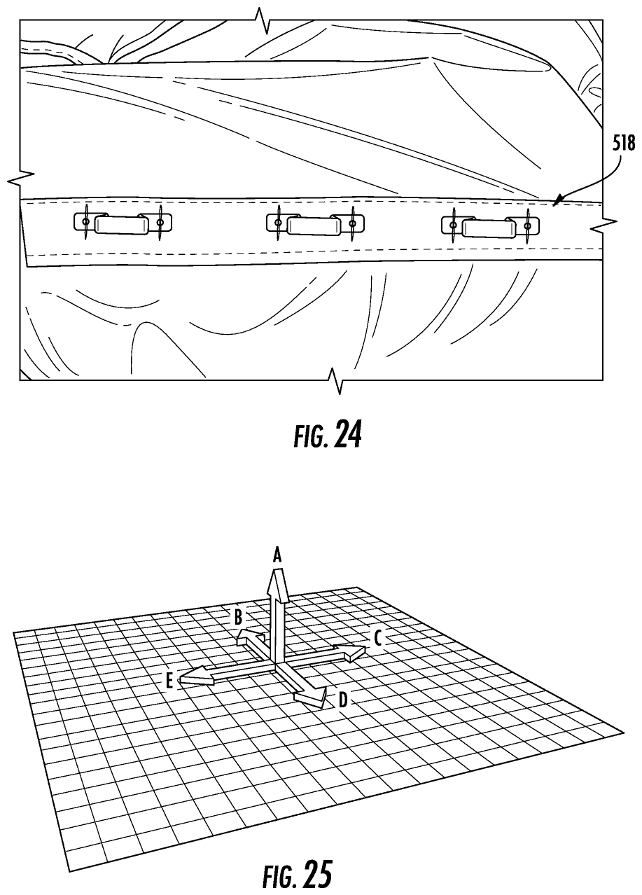

A 20 inch by 40 inch sheet of paper with a four by eight grid of 5 inch square boxes was centered on the bottom of the tent. This grid is used to divide the tent into 32 equal sectors for PAR measurements. An Apogee light meter, model MQ-210, was used for all light measurements and the readout was in units of photosynthetic active radiation (“PAR”). The PAR meter sensor was secured to a fixture for the measurements. Vertical measurements were obtained with the PAR sensor pointing straight up towards the top of the tent. Horizontal measurements were taken by orienting the PAR sensor in the horizontal orientation relative to the top of the tent. To assess reflected light, the horizontal measurements were taken at 0, 90, 180 and 270 degrees (FIG. 25). Measurements were taken for each square of the grid at the bottom of the tent and at 1, 2, 3, 4 and 5 feet from the bottom of the tent. The LED lights were switched on and allowed to reach a stable operating temperature and intensity before any measurements were taken.

The average of the vertical PAR values for the HLA, CGL and CGL & HLA are shown in FIG. 26. The average vertical light intensity for the HLA was similar from 0 to 4 feet. In contrast, the CGL intensity steadily increased from the bottom of the grow tent to the 4-foot level. The combination of the HLA and CGL provided the greatest light intensity and the intensity increased with the distance from the bottom of the grow tent. The HLA vertical light intensity was markedly different than the CGL. These results demonstrate the HLA provides an even distribution of light when measured in the vertical orientation.

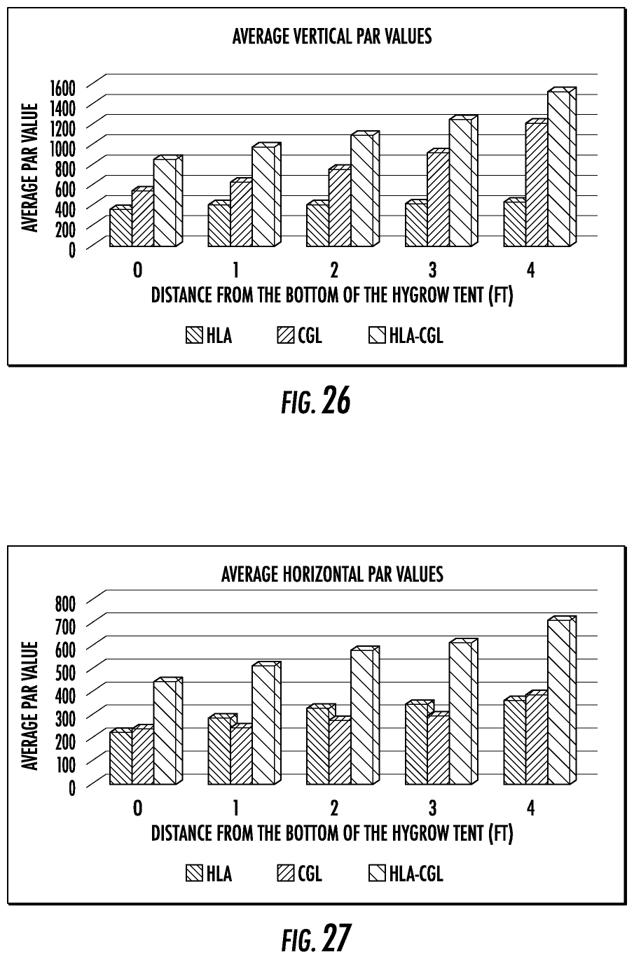

The average of the horizontal PAR values for the HLA, CGL and CGL & HLA are shown in FIG. 27. The average horizontal light intensity for the HLA and the CGL was similar from 0 to 4 feet. The average horizontal light intensity for the HLA and for the CGL at 0, 1, 2 and 3 feet from the bottom of the grow tent were similar, although at 1, 2 and 3 feet the HLA was slightly brighter. In contrast, the CGL & HLA intensity steadily increased from the bottom of the grow tent to the 4-foot level. These results demonstrate the HLA provides a greater or equal intensity of reflected light compared to the CGL.

The average PAR values for all the measurements are shown in FIG. 28. The average PAR values for the HLA and CGL are comparable from zero to 3 feet. As the PAR meter is positioned closer to the CGL the average of all the measurements exceeds the level observed for the HLA. The highest intensity values were observed for the combination of the HLA and CGL. The intensity steadily increased from the bottom to the top of the grow tent.

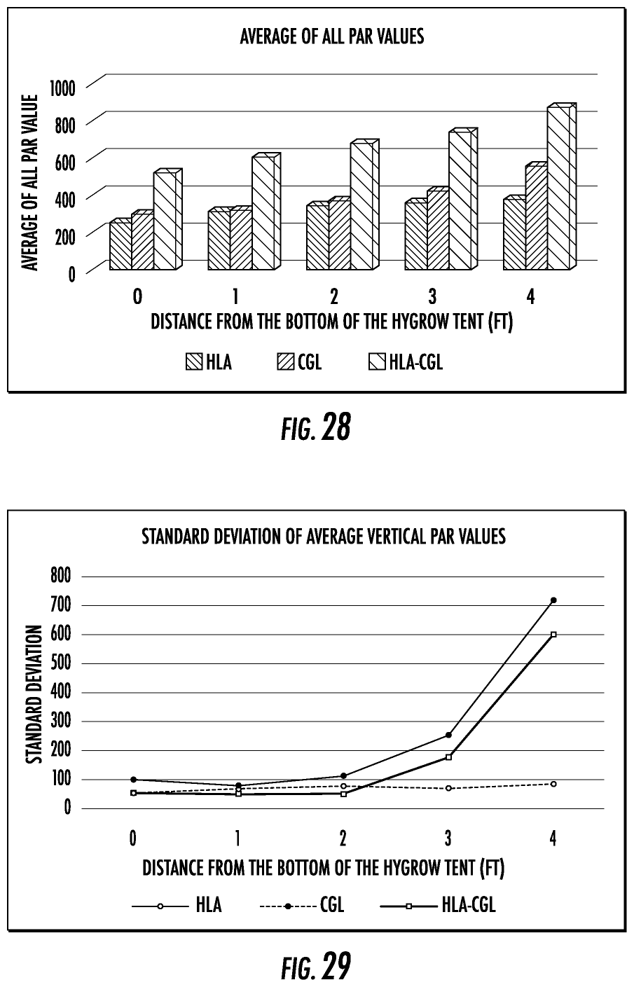

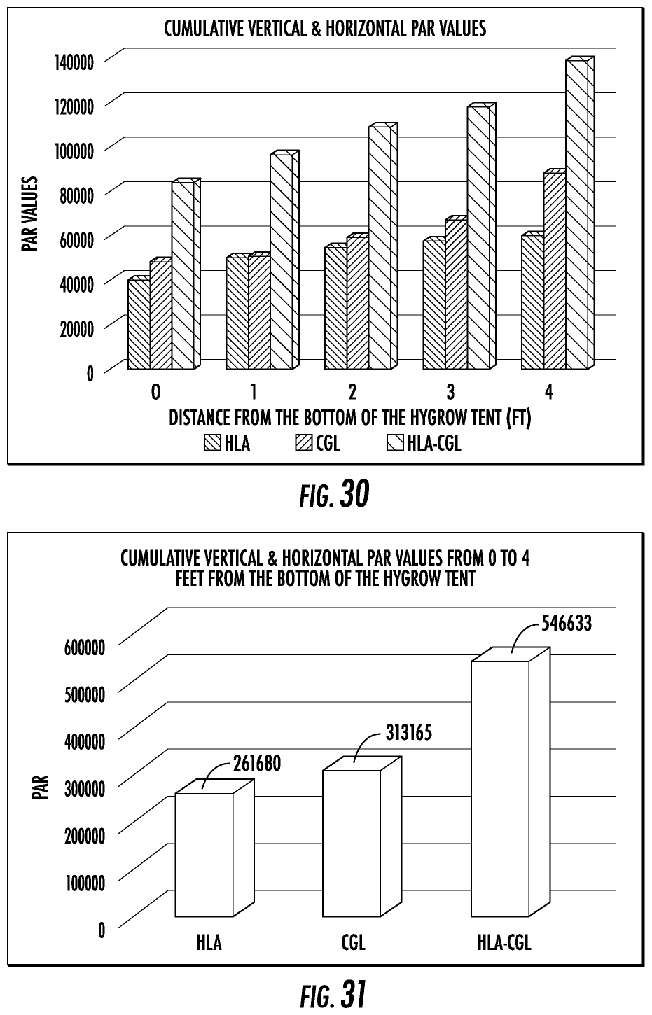

The uniformity of the lighting was determined by calculating the standard deviation of the average vertical PAR values (FIG. 29). The standard deviation of the HLA vertical measurements was slightly less than 100 for all the height levels in the grow tent, indicating that the light intensity was very evenly distributed. As expected for an overhead light, the standard deviation markedly increased as the PAR meter was positioned closer and closer to the CGL. The combination of the CGL and HLA resulted in a slightly improved uniformity of light distribution compared to the CGL alone. These results prove that the HLA provides the most uniform distribution of light intensity. In addition, the combination of the HLA and the CGL provides a significant increase in light intensity while also improving the uniformity of the light intensity.

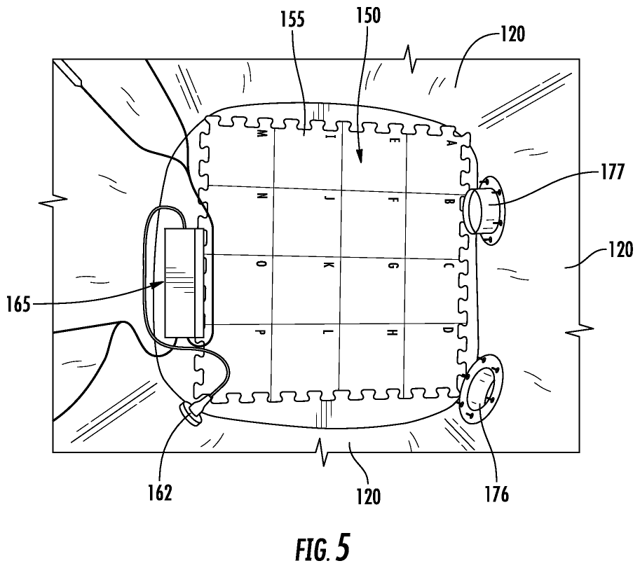

The light delivered to the grow tent can be examined by adding all the PAR measurements at each level in the tent to arrive at cumulative PAR Values. The cumulative PAR values as a function of the height from the bottom of the grow tent are shown in FIG. 8. These data show that the light delivered in the grow tent at each level is similar between the HLA and CGL. More light is delivered by the combination of the HLA and CGL, with the light intensity steadily increasing from the bottom of the grow tent to the 4-foot level. Finally, the total light delivered to the tent is arrived at by adding all the PAR measurements at all levels of the tent for each type of lighting (FIG. 31). The total light delivered by the CGL is about 20% greater than the HLA. The combination of HLA and CGL delivers about double the amount of light of the HLA and CGL alone.

In conclusion, the HLA provides a significantly more uniform distribution of light compared to the CGL. In addition, the uniformity of light distribution does not result in significantly less overall light intensity compared to the CGL. The combination of the HLA and the CGL results in a significant, almost doubling, of the overall light delivery, while improving the uniformity of light distribution of the CGL alone. It was surprising and unexpected that the combined HLA and CGL had greater light intensity and less variability.

While embodiments of this disclosure have been described, it is not intended that the disclosure be limited thereto, as it is intended that the disclosure be as broad in scope as the art will allow and that the specification be read likewise. Therefore, the above description should not be construed as limiting, but merely as exemplifications of presently disclosed embodiments. Thus, the scope of the embodiments should be determined by the appended claims and their legal equivalents, rather than by the examples given.

Persons skilled in the art will understand that the products and methods specifically described herein are non-limiting exemplary embodiments. The features illustrated or described in connection with one exemplary embodiment may be combined with the features of other embodiments. Various alternatives and modifications can be devised by those skilled in the art without departing from the disclosure. Accordingly, the present disclosure is intended to embrace all such alternatives, modifications and variances. As well, one skilled in the art will appreciate further features and advantages of the present disclosure based on the above-described embodiments. Accordingly, the present disclosure is not to be limited by what has been particularly shown and described, except as indicated by the appended claims.

1. An inflatable grow tent comprising:
a base surface, a top surface, and a plurality of sidewalls, the sidewalls being of a light material and including an integrated lighting system having a two-dimensional array of light emitting diodes (“LEDs”) attached to at least one of the plurality of sidewalls;
an additional source of light adjacent the top surface of the grow tent;
a plurality of support members configured to structurally support the grow tent; and
an air circulation assembly including an air blower and a carbon filter, the air blower blowing air to inflate the grow tent.

2. The inflatable grow tent of claim 1, wherein the plurality of support members are poles.

3. The inflatable grow tent of claim 1, wherein the sidewalls have an exterior made from canvas.

4. The inflatable grow tent of claim 1, wherein the sidewalls have an interior that is reflective.

5. The inflatable grow tent of claim 4, wherein the interior of the sidewalls comprises Mylar.

6. The inflatable grow tent of claim 1, wherein the plurality of support members form a frame external of the plurality of sidewalls.

7. The inflatable grow tent of claim 1, wherein the LEDs strips are disposed in parallel rows extending towards the top surface.

8. The inflatable grow tent of claim 1, wherein the LEDs are attached to the at least one of the plurality of sidewalls by fabric reinforced clips.

9. The inflatable grow tent of claim 8, wherein the fabric reinforced clips are attached to the at least one of the plurality of sidewalls by sewing.

10. The inflatable grow tent of claim 1, wherein the LEDs are attached by clips extending in horizontal rows.

11. The inflatable grow tent of claim 1, wherein the LEDs are a plurality of LED strips.

12. An inflatable grow tent comprising:
a base surface, a top surface, and a plurality of sidewalls, the sidewalls including an integrated lighting system having a two dimensional array of light emitting diodes (“LEDs”) attached to at least one of the plurality of sidewalls; and
an additional source of light adjacent the top surface of the grow tent; and
a plurality of support members configured to structurally support the grow tent.

13. The inflatable grow tent of claim 12, wherein the plurality of support members are poles.

14. The inflatable grow tent of claim 12, wherein the sidewalls have an exterior made from canvas.

15. The inflatable grow tent of claim 12, wherein the sidewalls have an interior that is reflective.

16. The inflatable grow tent of claim 15, wherein the interior of the sidewalls comprises Mylar.

17. The inflatable grow tent of claim 12, wherein the LEDs are disposed in parallel rows extending towards the top surface.

18. The inflatable grow tent of claim 12, wherein the plurality of support members form a frame external of the plurality of sidewalls.

19. The inflatable grow tent of claim 12, wherein the plurality of support members are connected by a plurality of connectors.

20. The inflatable grow tent of claim 12, further including an accessory attachment member positioned adjacent an exterior of one of the plurality of sidewalls, the accessory attachment member including a metal plate and a support configured to receive the support member therethrough.

21. The inflatable grow tent of claim 20, further including an accessory positioned adjacent an interior of the one of the plurality of sidewalls in alignment with the accessory attachment member, the accessory including a magnetic portion configured to attach to the metal plate of the accessory attachment member.

22. The inflatable grow tent of claim 21, wherein the accessory includes a hook.

23. The inflatable grow tent of claim 21, further including an air circulation assembly including an air blower and a carbon filter.

24. The inflatable grow tent of claim 12, wherein the LEDs are attached to the at least one of the plurality of sidewalls by fabric reinforced clips.

25. The inflatable grow tent of claim 24, wherein the fabric reinforced clips are attached to the at least one of the plurality of sidewalls by sewing.

26. The inflatable grow tent of claim 12, wherein the LEDs are attached by clips extending in horizontal rows.

27. The inflatable grow tent of claim 12, wherein the LEDs are a plurality of LED strips.

28. A method of installing an inflatable grow tent, comprising:
providing an external support system having an upper support, a lower support, and a plurality of side supports extending between the upper support and the lower support;
placing the grow tent inside the support system, the grow tent having a base surface, a top surface, and a plurality of sidewalls, the base surface, top surface and plurality of sidewalls being made of a light material, the grow tent having a source of light attached to at least one of the sidewalls; and
introducing air into the grow tent to inflate the grow tent.

29. The method of claim 28, further comprising attaching the grow tent to the support system.

30. The method of claim 28, wherein the light source is a plurality of LEDs attached to at least one of the sidewalls in a two-dimensional array.

31. The method of claim 29, further comprising connecting the LEDs to a power source.

32. The method of claim 28, wherein the source of light is attached to the at least one sidewall by sewing.

33. The method of claim 28, further comprising attaching an additional light source to the top surface.
